(19) United States
(12) Patent Application Publication
(10) Pub. No.: US 2003/0063321 A1
(43) Pub. Date: Apr. 3, 2003

(54) Image management device, image management method, storage and program

(75) Inventors: Daisuke Inoue, Kanagawa (JP); Naoki Shimada, Tokyo (JP); Takahiro Onsen, Kanagawa (JP); Koji Yoshida, Kanagawa (JP)

Correspondence Address: HOGAN & HARTSON L.L.P., 500 S. GRAND AVENUE, SUITE 1900, LOS ANGELES, CA, 90071-2611, US

(73) Assignee: CANON KABUSHIKI KAISHA

(21) Appl. No.: 10/254,612

(22) Filed: Sep. 25, 2002

(30) Foreign Application Priority Data
Sep. 28, 2001 (JP) 303230/2001
Sep. 20, 2002 (JP) 274500/2002

(51) Int. Cl. H04N 1/21; H04N 1/23

(52) U.S. Cl. 358/302

(57) ABSTRACT

An image management apparatus that transmits image data to an image processing apparatus is provided. The image management apparatus includes a sound input unit that inputs voice message relating to image data photographed by a digital camera. When one of the image data is selected and a voice message relating to the selected image data is input via the sound input unit, a translation unit of the image management apparatus automatically extracts keywords from the voice message. The translation unit determines one of the keywords as a title, and sets the title as a file name of the image data. The extracted keywords are set as data for searching images, and transmitted together with the selected image data to the image processing apparatus.

### FIELD OF THE INVENTION

The present invention relates primarily to a device and a method for managing image data in photographing devices and computers, and to an image data management technology to manage photographed image data using a server on a network.

### DESCRIPTION OF RELATED ART

Conventionally, information processing systems that have been known allow image data, which are electronic photographs photographed using image photographing devices such as digital cameras, to be shared, referred to and edited by a plurality of users by storing the image data in a server connected to the Internet.

In such information processing systems, a user can designate on a Web browser the image data that he or she wishes to store, add a title or a message to the image data, and upload it.

In addition, image photographing devices such as digital cameras that allow input of titles and messages for image data are known; as for uploading image data, there are terminal devices known that allow image data to be sent via a network to a specific location by connecting an image photographing device, such as a digital camera, to a portable communication terminal, such as a cellular telephone or a PHS (personal handy phone system).

Furthermore, information processing systems that correlate additional information such as voice data with image data and store them together are also known. In such information processing systems, the speech vocalized by a user can be recorded and stored as a message with an image data, or the speech vocalized by a user can be recognized with a voice recognition device, and the recognition result converted into text data, correlated to an image data and stored.

Among voice recognition technologies, a word spotting voice recognition technology is known, in which a sentence a user speaks is recognized using a voice recognition dictionary and a sentence analysis dictionary, and a plurality of words included in the sentence is extracted.

However, as image photographing devices such as digital cameras become widely used, the number of image data such as electronic photographs is becoming enormous; the user must attach a title, a text message or a voice message individually to each image data photographed, which results in having to invest a huge amount of time and effort in organizing and storing image data.

When keywords used in searches are set and correlated with an image data, along with a title or a message attached to the image data, the title, the message and the search keywords, each consisting of one or more keywords, must be input individually for each image data, even though in many cases they are very similar to each other; this results in a waste in terms of repeated input operations of similar words.

### SUMMARY OF THE INVENTION

The present invention was conceived in view of the problems entailed in prior art.

The present invention primarily relate to an apparatus and a method to efficiently set additional information to image data in order to manage images.

In view of the above, an embodiment of the present invention pertains to an image management apparatus that transmits image data to an image processing apparatus, the image management apparatus comprising: an image input unit that inputs image data to be transmitted; a sound input unit that inputs voice information relating to the image data input via the image input unit; a translator that voice-recognizes the voice information input via the sound input unit and converts the voice information into keyword information containing at least one keyword; and a transmission unit that adds the keyword information to the image data and transmits the image data with the keyword information to the image processing apparatus.

The present invention also relates to an apparatus and a method that are capable of setting additional information using more appropriate expression. In this respect, in one aspect of the present invention, the image management apparatus may further include an obtaining unit that obtains time information correlated to the image data to be transmitted, wherein the translator extracts keywords based on the voice information and the time information.

Furthermore, in another aspect of the present invention, the image management apparatus may further comprises an obtaining unit that obtains geographical positional information correlated to the imaged data to be transmitted, wherein the translator extracts keywords based on the voice information and the positional information.

Other purposes and features of the present invention shall become clear in the description of embodiments and drawings below.

### BRIEF DESCRIPTION OF THE DRAWINGS

FIG. 1 shows a system configuration diagram indicating the general configuration of an information processing system in accordance with a first embodiment of the present invention.

FIG. 2 shows a block diagram indicating the electrical configuration of an adaptor.

FIG. 3 shows a diagram indicating the configuration of software installed on the adaptor.

FIG. 4 shows a schematic illustrating information set in a voice information setting file.

FIG. 5 shows a flowchart indicating a processing unique to the first embodiment.

FIG. 6 shows a configuration diagram indicating the general configuration of an application server according to the second embodiment of the present invention.

FIG. 7 shows a schematic indicating the configuration of software installed on a voice processing section of the application server in FIG. 6.

FIG. 8 shows a flowchart indicating a processing unique to the second embodiment.

FIG. 9 shows a flowchart indicating a processing unique to the third embodiment.

FIG. 10 shows a block diagram indicating the electrical configuration of an adaptor according to the fourth embodiment.

FIG. 11 shows a flowchart indicating a processing unique to the fourth embodiment.

### DETAILED DESCRIPTION OF THE PREFERRED EMBODIMENT

Below, embodiments of the present invention will be described with reference to the accompanying drawings.

[First Embodiment]

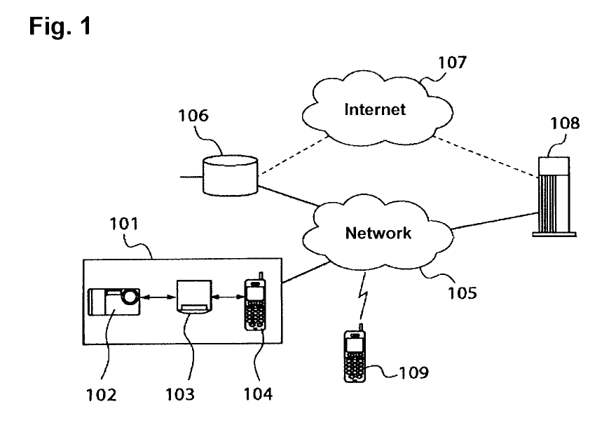

FIG. 1 shows a system configuration diagram indicating the general configuration of an information processing system in accordance with the first embodiment of the present invention.

The information processing system includes a terminal device 101, an external provider 106, an application server 108, an information terminal device 109, a communication network 105 that connects the foregoing components so that they can send and receive data, and the Internet 107.

The terminal device 101 has a digital camera 102, an adaptor 103 and a portable communication terminal 104. The digital camera 102 has a display panel to check photographed images, and the display panel in the present embodiment is used to select image data that are to be sent to the application server 108.

Images photographed by the digital camera 102 are assigned filenames and stored according to predetermined rules. For example, they are stored according to a DCF (Design rule for Camera Format). Detailed description of the DCF is omitted, since it is known.

The adaptor 103 has a function unique to the present embodiment as described later, in addition to its fundamental function of relaying image data that are sent from the digital camera 102 to the portable communication terminal 104. The portable communication terminal 104 is provided to send the image data photographed by the digital camera 102 to the application server 108 and functions as a wireless communication terminal. The communication network 105 comprises a public telephone line, ISDN or satellite communication network; in the present embodiment, however, it is conceived to be a public telephone line network that includes wireless network.

The external provider 106 intercedes between the Internet 107 and the communication network 105; it provides a dial-up connection service to the information terminal device 109 and manages and operates user accounts for Internet connection.

The application server 108 communicates according to a predetermined protocol and has functions to receive, store, refer to, search and deliver image data and/or voice data. The information terminal device 109 comprises a personal computer or a portable communication terminal and has functions to search, refer to, edit, receive and print via the communication network 105 the image data and/or the voice data managed by the application server 108.

Next, the adaptor 103, which is unique to the present embodiment, is described below.

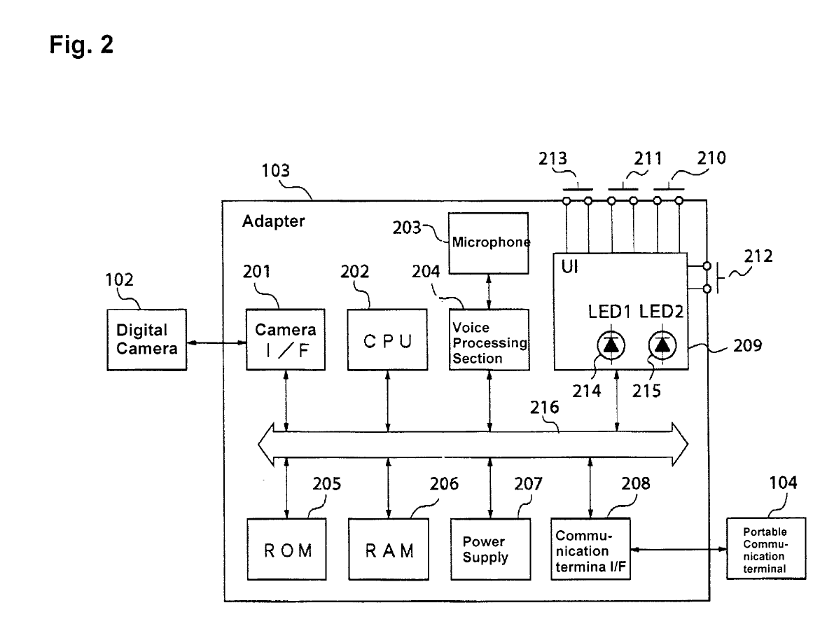

FIG. 2 is a block diagram indicating the electrical configuration of the adaptor 103.

The adaptor 103 according to the present embodiment is connected to the portable communication terminal 104 via a communication terminal interface 208, which in turn is connected to an internal bus 216.

The adaptor 103 is also connected to the digital camera 102 via a camera interface 201, which in turn is connected to the internal bus 216. In the present embodiment, the adaptor 103 and the digital camera 102 are connected by a USB (universal serial bus), so that the adaptor 103 can obtain, via the USB and the camera interface 201, image data photographed by the digital camera 102.

To the internal bus 216 are also connected a CPU 202 that controls the overall operation of the adaptor 103, a ROM 205 that stores an internal operation program and settings, a RAM 206 that temporarily stores a program execution region and data received or to be sent, a user interface (U/I) 209, a voice processing section 204, and a power source 207. The voice processing section 204 is configured so that a microphone 203 can be connected to it.

A program that controls the present embodiment is stored in the ROM 205.

The U/I 209 has a power source button 210 that turns on and off power supplied by the power source 207, a transmission button 201 that instructs the transmission of image data, a voice input button 212 that starts voice input processing, and an image selection button 213 that instructs to take into the adaptor 103 the image data displayed on the display panel of the digital camera 102. In addition, the U/I 209 has three-color LEDs 214 and 215 that notify the user of the status of the adaptor 103. The voice processing section 204 controls the microphone 203 to begin and end taking in speech and to record.

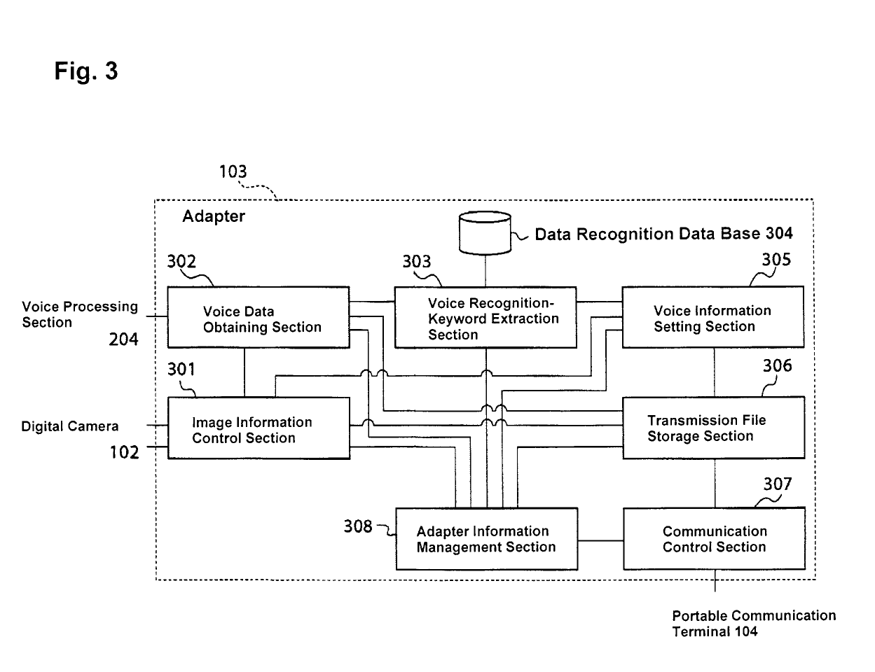

The ROM 205 comprises a rewritable ROM and allows software to be added or changed. In the ROM 205 are stored software (a control program) shown in FIG. 3, as well as various programs, the telephone number of the portable communication terminal 104 and an adaptor ID. The programs stored in the ROM 205 can be rewritten by new programs that are downloaded via the camera interface 201 or the communication terminal interface 208. The telephone number of the portable communication terminal 104 that is stored in the ROM 205 can be similarly rewritten.

The CPU 202 controls the portable communication terminal 104 in terms of making outgoing calls, receiving incoming calls and disconnecting based on the programs stored in the ROM 205. The portable communication terminal 104 outputs to the adaptor 103 its own telephone number and information concerning incoming calls (ring information, telephone numbers of incoming calls, and status of the portable communication terminal 104). Through this, the adaptor 103 can obtain information such as the telephone number of the portable communication terminal 104.

The adaptor 103 has the following function as a function unique to the present embodiment: the adaptor 103 has a function to voice-recognize a voice message input through the microphone 203, extract words from the message, convert the words into text data, and attach them to the image data as keywords for image searches and a title.

The electrical configuration of the adaptor 103 has been indicated as illustrated in FIG. 2, but different configurations may be used as long as the configuration allows the control of the digital camera 102, voice processing, the control of the portable communication terminal 104, and the transmission of specific files.

FIG. 3 is a functional block diagram indicating the configuration of software that is installed on the adaptor 103 and that realizes the function unique to the present embodiment.

Reference numeral 301 denotes an image information control section that obtains, via the camera interface 201, list information of image data or specific image data that are stored in the digital camera 102, and stores them. In other words, when the image selection button 213 is pressed, the image information control section 301 obtains and stores the image data displayed on the display panel of the digital camera 102. The image information control section 301 also performs change processing to change the filename of image data obtained.

Reference numeral 302 denotes a voice data obtaining section that records voice data taken in via the microphone 203 and the voice processing section 204, and after converting the voice data into digital data that can be processed by the CPU 202, transfers the digital data to a voice recognition/keyword extraction section 303, which is described later. The input processing of voice data by the voice data obtaining section 302 begins when the voice input button 212 is pressed. The recorded voice data is transferred to a transmission file storage section 306, which is described later, as a voice file.

Reference numeral 303 denotes the voice recognition/keyword extraction section that uses a voice recognition database 304 to analyze the voice data it receives from the voice data obtaining section 302. In the voice recognition processing, one or more keywords (words) can be extracted from the input voice data using a word spotting voice recognition technology.

In the voice recognition database 304 is registered information required for the voice recognition processing and the keyword extraction processing. There may be a plurality of the voice recognition databases 304, and they may also be downloaded via the camera interface 201 or the communication terminal interface 208 and registered. The results of analysis by the voice recognition/keyword extraction section 303 are transferred to a voice information setting section 305, which is described later.

For example, the voice recognition/keyword extraction section 303 analyzes the voice data it receives by using a phonemic model, a grammar analysis dictionary and recognition grammar that are registered in the voice recognition database 304 and discriminates the voice data into a word section and an unnecessary word section. Those parts determined to belong to the word section are converted into character string data, which serve as keywords, and transferred to the voice information setting section 305.

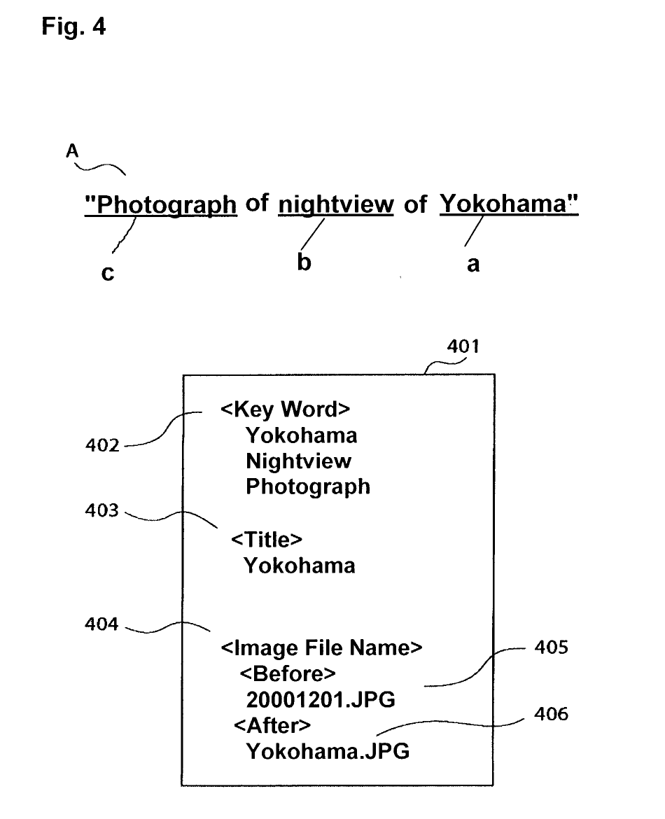

The voice information setting section 305 correlates the image data stored in the image information control section 301 with a title and keywords based on the results of analysis (extracted keywords) it receives from the voice recognition/keyword extraction section 303. In other words, the voice information setting section 305 correlates one or more extracted keywords (character string data) with the image data as the image data's keywords, and sets one of the keywords as the title (the part preceding the extension (for example, “.jpg”) in filenames) of the image data. The contents of the title set and the keywords are stored as a voice information file. The voice information file will be described later with reference to FIG. 4.

When setting the title of an image data, a list of image filenames in the digital camera 102 and that is stored in the image information control section 301 is referred to, and the title is set so as not to duplicate any existing image filenames referred to. The title (character string data) set by the voice information setting section 305 is transferred to the image information control section 301 and communicated to the corresponding digital camera 102.

The filenames of image data within the digital camera 102 (i.e., the filenames that were assigned according to the DCF in the digital camera 102) may be rewritten as the character string data expressed as titles, but it is preferable not to change the filenames themselves and instead to store the filenames as auxiliary information correlated with corresponding image data. The reasons for this are to eliminate the inconvenience of not being able to manage images as a result of having filenames in formats other than the DCF, and to be able to recognize the image data with new filenames assigned at the destination, which can be done as long as the filenames are stored as auxiliary information.

More preferably, new filenames may be stored as auxiliary information along with information used to recognize the destination. By doing this, even if different filenames are assigned for a single image data by various destinations, the image data with new filenames assigned at various destinations can still be recognized.

Reference numeral 306 denotes the transmission file storage section. When the transmission button 211 is pressed, the transmission file storage section 306 obtains the image data (an image file) from the image information control section 301, the voice file from the voice data obtaining section 302, and the voice information file from the voice information setting section 305, and stores them as a transmission file. Once storing the transmission file is completed, the transmission file storage section 306 sends a transmission notice to the communication control section 307. However, the file to be sent may only be the image file; for example, if there is no applicable voice file or voice information file, only the image file is transmitted.

Reference numeral 307 denotes a communication control section, which controls the portable communication terminal 104 via the communication terminal interface 208 in terms of making outgoing calls, receiving incoming calls and disconnecting in order to connect with, and send transmission files to, the application server 108 via the communication network 105 and the Internet 107.

In connecting with the application server 108, the communication control section 307 uses adaptor information, such as the telephone number and the adaptor ID, that is required for connection and that is stored in the ROM 205 of the adaptor 103, for a verification processing with the application server 108. When the adaptor 103, and by extension the digital camera 102, is verified by the application server 108 and the connection is established, the communication control section 307 sends to the application server 108 a file that is stored in the transmission file storage section 306 and that is to be sent.

Reference numeral 308 denotes an adaptor information management section, which manages internal information of the adaptor 103, such as rewriting the internal programs with new software downloaded via the camera interface 201 or the communication terminal interface 208, or changing the telephone number and the adaptor ID that are stored in the ROM 205 and that are required for connection with the application server 108.

Next, referring to FIG. 4, the contents of the voice information file created by the voice information setting section 305 will be described.

A phrase A in FIG. 4 indicates an example of extracting keywords from a speech that was input. When a user voice-inputs “Photograph of night view of Yokohama,” the underlined sections, a (Yokohama), b (night view), c (photograph) of the phrase A in FIG. 4 are extracted by the voice recognition/keyword extraction section 303 as keywords (character string data). These keywords will be used to search the desired image data (the image file) in the application server 108.

Reference numeral 401 in FIG. 4 denotes a voice information file, and the extracted keywords (character string data) are registered in a keyword column 402. One of the keywords registered in the keyword column 402 is registered in a title column 403. As described before, when registering a title, a list of image filenames (primarily filenames of image data already sent) inside the digital camera 102 and stored in the image information control section 301 is referred to and the title is set so as not to duplicate any existing image filenames (the part excluding the file extension). Through this processing, the danger of registering different image data under the same filename in the application server 108 is avoided.

Image filename information is registered in an image filename column 404, in which the image filename in the digital camera 102 stored in the image information control section 301 is registered in <Before> column 405, while the title registered in the title column 403 is registered in <After> column 406.

After the voice information file is created, the image information control section 301 replaces the image filename in the digital camera 102 stored in the image information control section 301, with the filename (i.e., the title) registered in <After> column 406.

The configuration of the software installed on the adaptor 103 has been described above using FIGS. 3 and 4. The software can be stored in the ROM 205, for example, and its function is realized mainly by having the CPU 202 execute the software. Different software configurations may be used, as long as the configuration allows the control of the digital camera 102, input of voice data, recognition of voice data, keyword extraction from voice data, automatic setting of titles and keywords for images, the control of the portable communication terminal 104, and transmission of specific files.

Further, in the present embodiment, the word spotting voice recognition technology is used to extract one or more keywords (words) from the voice data derived from voice input, but the voice recognition device is not limited to the word spotting voice recognition technology as long as the voice recognition device can recognize the voice data derived from voice input and can extract one or more keywords (words).

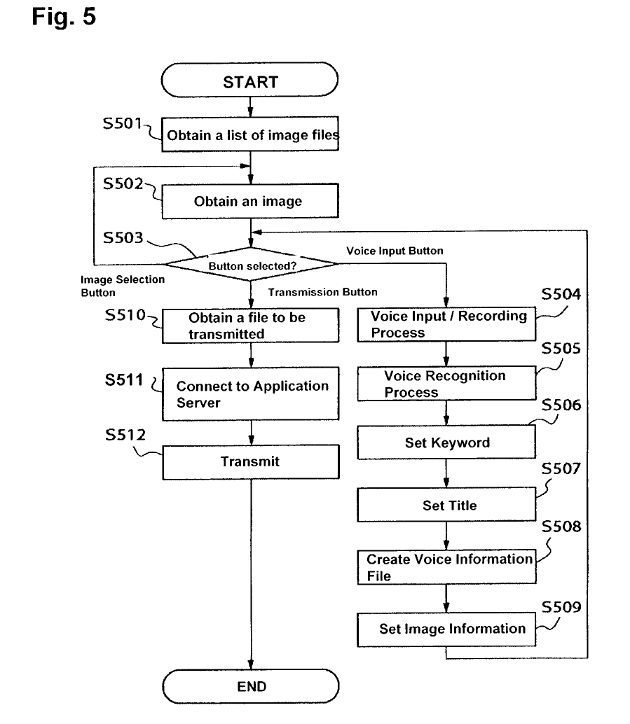

Next, we will use a flowchart in FIG. 5 to describe a processing unique to the present embodiment. FIG. 5 is a flowchart indicating a processing by the adaptor 103.

When adding voice information to a specific image data in the digital camera 102 and transmitting it to the application server 108, which is connected to the communication network 105 and the Internet 107, to have the application server 108 manage the image data with voice information, the image information control section 301 in step S501 obtains the filenames of all image data stored in the digital camera 102 and stores them as image list information.

Next, in step S502, the image information control section 301 waits for the image selection button 213 to be pressed, which would select the image data to add voice information to and to send. After displaying and confirming the desired image data on the display panel of the digital camera 102, a user presses the image selection button 213 of the adaptor 103.

When the image selection button 213 is pressed, the image information control section 301 obtains via the camera interface 201 the image data displayed on the display panel of the digital camera 102 and stores it. When the image information control section 301 finishes obtaining and storing the image data, it notifies the voice data obtaining section 302 and the transmission file storage section 306 that obtaining the image data has been completed.

Next, upon receiving the notice that obtaining the image data has been completed from the image information control section 301, the voice data obtaining section 302 and the transmission file storage section 306 monitor in step S503 for the voice input button 212 and the transmission button 211, respectively, to be pressed.

To send the selected image data to the application server 108, the user presses the transmission button 201, which controls the portable communication terminal 104, to perform a transmission processing. To add voice information to the selected image data, the user presses the voice input button 212, which controls the voice processing section 204, to input a voice message through the microphone 203.

When the user presses the transmission button 211, the processing proceeds to step S510 and the transmission file storage section 306 begins the transmission processing. When the user presses the voice input button 212, the processing proceeds to step S504 and the voice data obtaining section 302 begins a voice processing. When the user presses the image selection button 213, the processing returns to step S502 to obtain another image data.

<When the Voice Input Button 212 is Pressed>

When the voice data obtaining section 302 detects that the voice input button 212 has been pressed in step S503, the processing proceeds to step S504 and the voice data obtaining section 302 controls the voice processing section 204 to begin inputting and recording the user's voice message through the microphone 203. Further, the voice data obtaining section 302, in addition to inputting and recording the user's voice message, converts the voice message that was input into appropriate digital data and sends it to the voice recognition/keyword extraction section 303. When the recording of the voice message is completed, the voice data obtaining section 302 stores the recorded message as a voice file and notifies the transmission file storage section 306 that the creation of the voice file is completed.

Next, in step S505, the voice recognition/keyword extraction section 303 uses the voice recognition database 304 to recognize, through the word spotting voice recognition technology, the voice data it received from the voice data obtaining section 302, and extracts one or more words as keywords (character string data) from the voice data.

Next, in step S506, the voice information setting section 305 stores as keywords for image searches the keywords (character string) that were extracted by the voice recognition/keyword extraction section 303.

Next, in step S507, the voice information setting section 305 selects one keyword from the keywords that were set as the keywords for image searches and sets and stores the selected keyword as the title of the image data. When doing this, the voice information setting section 305 refers to a list of image filenames, which is stored in the image information control section 301, for image data already sent and sets the title of the image data so as not to duplicate any existing image filenames referred to.

Next, in step S508, the voice information setting section 305 writes in the voice information file 401 the keywords and the image data title that were stored in step S506 and step S507. Further, the voice information setting section 305 writes in the voice information file 401 the filename (the filename stored in the digital camera) of the selected image data and the new filename as replaced with the title set (see FIG. 4). After the creation of the voice information file 401 is completed, the voice information setting section 305 notifies the transmission file storage section 306 and the image information control section 301 that the creation of the voice information file 401 has been completed.

Next, upon receiving from the voice information setting section 305 the notice that the creation of the voice information file 401 has been completed, the image information control section 301 refers in step S508 to the title (the character string data) set by the voice information setting section 305 and rewrites the filename of the corresponding image data in the digital camera 102 as the character string data as represented by the title set. Once rewriting the filename is completed, the processing returns to step S503.

<When the Transmission Button 211 is Pressed>

When the transmission file storage section 306 detects that the transmission button 211 has been pressed in step S503, the processing proceeds to step S510 and the transmission file storage section 306 obtains the image data (the image file) from the image information control section 301, the voice file from the voice data obtaining section 302, and the voice information file 401 from the voice information setting section 305.

When there is no notice from the voice data obtaining section 302 that the creation of the voice file has been completed, i.e., when the user did not input any voice messages, the transmission file storage section 306 stores only the image data. After obtaining all files to be sent, the transmission file storage section 306 notifies the communication control section 307 that obtaining files to be sent has been completed.

Next, upon receiving the notice from the transmission file storage section 306 that obtaining the files to be sent has been completed, the communication control section 307 in step S511 controls the portable communication terminal 104 via the communication terminal interface 208 and begins a connection processing with the application server 108. In the connection processing with the application server 108, the communication control section 307 uses the telephone number and the adaptor ID, which are stored in the ROM 205 of the adaptor 103 and are required for connection, for verification with the application server 108.

Next, when the connection with the application server 108 is established, the communication control section 307 in step S512 sends to the application server 108 via the communication terminal interface 208 and the portable communication terminal 104 the files that were obtained by the transmission file storage section 306 and that are to be sent, and terminates the processing.

A more preferable embodiment is one in which the communication control section 307, after connecting with the application server 108 in step S511, inquires whether, in the application server 108, there are any data whose filenames are identical to the filename of the image to be sent, and if there is an identical filename, a different filename may be created for the image to be sent by using a different keyword or using the same keyword but with a numeral being added thereto.

By doing this, any duplication of filenames in the application server 108 can be prevented.

The method for obtaining a specific image data from the digital camera 102, recording and voice-recognizing a voice message that is input, extracting some words from the message and converting them into text data, and automatically setting the text data as keywords for image searches and a title, all of which takes place in the adaptor 103 of the information processing system, is as described using the flowchart in FIG. 5. However, the order of the steps that take place in the adaptor 103 and that are involved in attaching voice information to an image data and transmitting it may be different, as long as the steps include controlling the digital camera 102, inputting voice data, recognizing the voice data, extracting keywords from the voice data, automatically setting an image title and keywords, controlling the portable communication terminal 104, and transmitting the specific file.

[Second Embodiment]

The functions of the overall system in accordance with a second embodiment of the present invention are fundamentally similar to those of the first embodiment. However, the two embodiments differ in that whereas in the first embodiment the adaptor 103 has the functions to input/output voice, recognize/synthesize voice, record voice messages, and automatically set titles and keywords, in the second embodiment an application server 108 has these functions. This involves sending only the image data ahead of other data to the application server 108 to be stored there, and setting a title and keywords later in the application server 108.

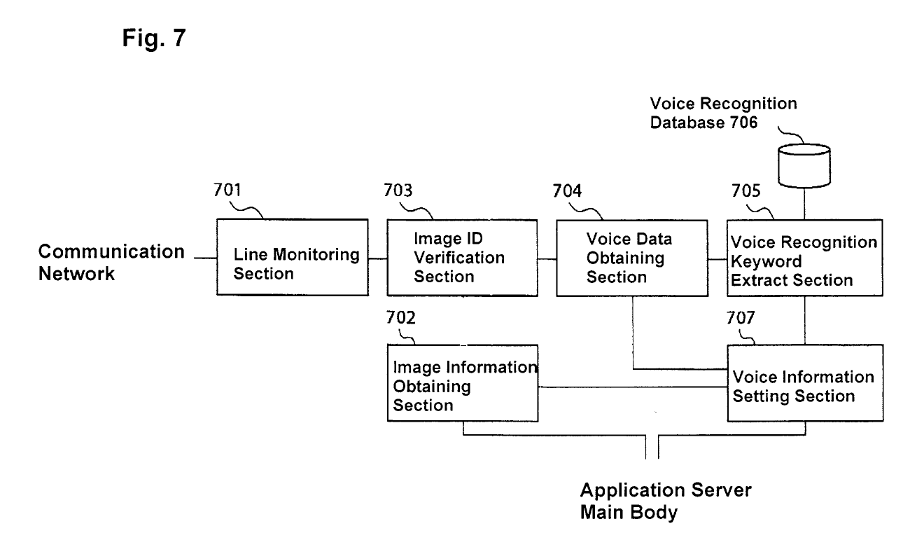

Consequently, the software shown in FIG. 4 is not installed on an adaptor 103 in the second embodiment, and instead software (see FIG. 7) that realizes nearly identical functions as the software indicated in FIG. 4 is installed on the application server 108; and the software installed on the application server 108 is stored in a memory, omitted from drawings, of the application server 108. As for hardware, the adaptor 103 may have a microphone 203, a voice processing section 204 and a voice input button 212, as long as the application server 108 has a device equivalent to the microphone 203, the voice processing section 204 and the voice input button 212.

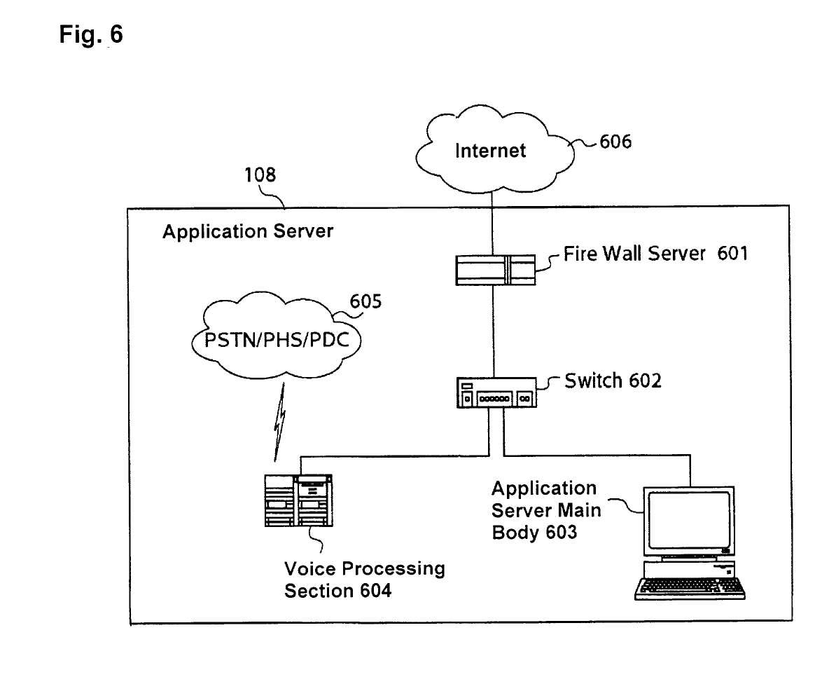

FIG. 6 shows a block diagram indicating the configuration of the application server 108 that according to the second embodiment has functions to input/output voice, recognize/synthesize voice, record voice messages, and automatically set titles and keywords.

In FIG. 6, reference numeral 601 denotes a firewall server that has a function to block unauthorized access and attacks from the outside and is used to safely operate a group of servers on an intranet within the application server 108. Reference numeral 602 denotes a switch, which functions to configure the intranet within the application server 108.

Reference numeral 603 denotes an application server main body that has functions to receive, store, edit, refer to, and deliver image data and/or voice data, and that also supports dial-up connection through PIAFS (PHS Internet Access Forum Standard), analog modem or ISDN. Image data and/or voice data that are transmitted from the adaptor 103 are stored in and managed by the application server main body 603. The application server main body 603 also has a function to issue an image ID and a password to each image data it receives.

Reference numeral 604 denotes a voice processing section that has functions to input/output voice, recognize/synthesize voice, record voice messages, and automatically set titles and keywords. The voice processing section 604 is connected to a communication network 605. The communication network 605 comprises a PSTN (Public Switched Telephone Network), a PHS network, or a PDC (Personal Digital Cellular) network.

As a result, users can call the voice processing section 604 of the application server 108 from a digital camera with communication function, a telephone, or a portable communication terminal 104 with telephone function to input voice messages to automatically set titles and keywords. Reference numeral 606 denotes the Internet. In addition to telephone lines, communication lines such as LAN or WAN, and wireless communications such as Bluetooth or infrared communication (IrDA; Infrared Data Association) may be used in the present invention.

FIG. 7 schematically shows a block diagram indicating the configuration of software installed on the voice processing section 604. In FIG. 7, reference numeral 701 denotes a line monitoring section, which monitors incoming calls from telephones and the portable communication terminal 104 via the communication network 605, rings, and controls the line.

Reference numeral 702 denotes an information obtaining section, which refers to, obtains and manages a list of filenames of image data stored in the application server main body 603, as well as the image ID's and passwords issued by the application server main body 603 when it receives image data.

Reference numeral 703 denotes an image ID verification section, which recognizes an image ID and an password input by the user, verifies them against image information managed by the image information obtaining section 702, and searches for an image data (a filename) that corresponds to the image ID. Users input the image ID and password using a keypad on telephones and the portable communication terminal 104.

Reference numeral 704 denotes a voice data obtaining section, which records a user's voice data taken in via the communication network 605, and after converting the voice data taken in into appropriate digital data, transfers it to a voice recognition/keyword extraction section 705, which is described later. The recorded voice data is transferred to the application server main body 603 via a voice information setting section 707, which is described later, as a voice file.

Reference numeral 705 denotes a voice recognition/keyword extraction section that uses a voice recognition database 706 to analyze the voice data it receives from the voice data obtaining section 704 and performs voice recognition. In the voice recognition processing, one or more keywords (words) can be extracted from the input voice data using a word spotting voice recognition technology.

The voice recognition database 706 is a database that has registered information required for the voice recognition processing and the keyword extraction processing. There may be a plurality of the voice recognition databases 706, and they may also be added and registered later. The results of analysis by the voice recognition/keyword extraction section 705 are transferred to the voice information setting section 707, which is described later.

The voice information setting section 707 correlates analysis results (extracted keywords and a title) that it receives from the voice recognition/keyword extraction section 705 with the image data that corresponds to the image ID that was verified by the image ID verification section 703 and the image information obtaining section 702.

In other words, the voice information setting section 707 correlates one or more extracted keywords (character string data) with the image data as keywords for image data searches, and sets one of the keywords as the title (a filename) of the image data. The contents of the title set and the keywords are stored as a voice information file. The voice information file is similar to the voice information file 401 (see FIG. 4) that was described in the first embodiment. When setting the title of an image, a list of image filenames that is managed by the image information obtaining section 702 is referred to, and the title is set so as not to duplicate any existing image filenames.

Information such as the title and the keywords that are set by the voice information setting section 707 is communicated to the destination of the image data, and the destination device correlates the communicated information such as the title with the image data that was sent and stores them. More preferably, information used to recognize the destination should be stored together with the communicated information.

The software configuration of the voice processing section 604 is as described using FIG. 7, but different software configurations may be used, as long as the configuration allows voice input from telephones or the portable communication terminal 104 via the communication network 605, recording, conversion to digital data, voice recognition of input voice data, extraction of keywords, automatic setting of titles and keywords for image data, and selection of specific images using image IDs and passwords.

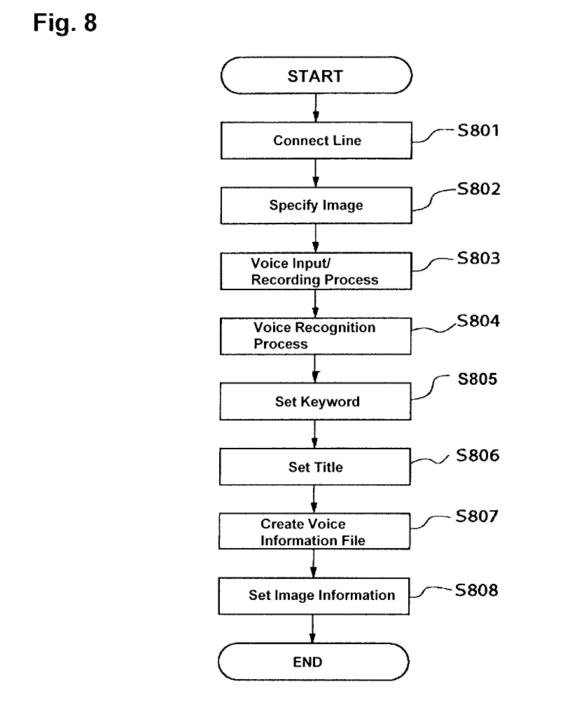

Next, referring to a flowchart in FIG. 8, descriptions will be made as to the details of a processing by the voice processing section 604 to add a voice message to an image data that was received from the adaptor 103 and to automatically set a title and keywords for the image data.

To add a voice message and a title and keywords to an image data in the application server 108 after the image data is sent from the adaptor 103, the user calls the voice processing section 604 of the application server 108 from a telephone or the portable communication terminal 104.

In step S801, the line monitoring section 701 monitors incoming calls from the user, and connects the line when there is an incoming call.

Next, in step S802, the user inputs the image ID and password for the image data using a keypad. The image ID verification section 703 recognizes the image ID and password that were input, compares them to image IDs and passwords managed by the image information obtaining section 702 to verify them, and specifies the matching image data.

Next, in step S803, the voice data obtaining section 704 begins to input and record a voice message via the communication network 605. In addition, the voice data obtaining section 704, in addition to inputting and recording the user's voice message, converts the voice message that was input into appropriate digital data and sends it to the voice recognition/keyword extraction section 705. When the recording of the voice message is completed, the voice data obtaining section 704 stores the recorded message as a voice file.

Next, the voice recognition/keyword extraction section 705 uses the voice recognition database 706 to voice-recognize the voice data it received from the voice data obtaining section 704, and extracts one or more words as keywords (character string data) from the voice data (step S804).

In the present embodiment, the word spotting voice recognition technology is used to extract one or more keywords (words) from the voice data derived from voice input, but the voice recognition device is not limited to the word spotting voice recognition technology as long as the voice recognition device can recognize the voice data derived from voice input and can extract one or more keywords (words).

Next, in step S805, the voice information setting section 707 stores as keywords for image searches the keywords (character string) that were extracted by the voice recognition/keyword extraction section 705.

Next, in step S806, the voice information setting section 707 selects one keyword from the keywords that were set as the keywords for searching images, and sets and stores the selected keyword as the title of the image data. The voice information setting section 707 refers to a list of image filenames managed by the image information obtaining section 702, i.e., a list of filenames stored in the application server main body 603, and sets the title of the image data so as not to duplicate any existing image filenames referred to.

Next, the voice information setting section 707 writes in a voice information file 401 the keywords and the image data title that were stored in step S805 and step S806 (step S807). Further in step S807, the voice information setting section 707 writes in the voice information file 401 the filename of the selected image data and the new filename as replaced with the title set.

When the creation of the voice information file 401 is completed, the voice information setting section 707 transfers to the application server main body 603 the voice file that was created in step S803 and the voice information file 401 (step S808). Further, information such as the title and the keywords that are set by the voice information setting section 707 is communicated to the destination (the adaptor 103 in this case) of the image data, and the destination device (a digital camera connected to the adaptor 103 in the present embodiment) correlates the communicated information such as the title with the image data that was sent and stores them.

The method for adding a voice message through the voice processing section 604 to an image data received from the adaptor 103 and automatically setting a title and keywords for the image data has been described using FIG. 8; however, the order of the steps involved may be different, as long as the steps include inputting voice via the communication network 605 from a telephone or the portable communication terminal 104, recording, converting to digital data, voice-recognizing input voice data, extracting keywords, automatically setting a title and keywords from the input voice data for the image data, and selecting a specific image using an image ID and a password.

[Third Embodiment]

The functions of the overall system in accordance with a third embodiment of the present invention are fundamentally similar to those of the first embodiment. However, the two differ in that in the third embodiment, an adaptor 103 updates a voice recognition database 304 based on date information of image data stored in a digital camera 102, which improves the voice recognition rate. This involves updating the voice recognition database 304 using a phonemic model typical of the season, a grammar analysis dictionary and recognition grammar, for example, based on the date information, in order to improve the recognition rate of voice data taken in.

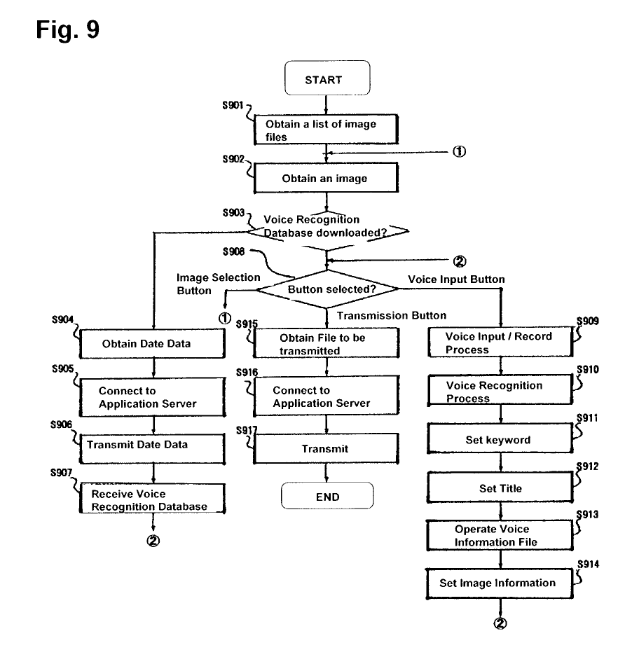

Referring to a flowchart in FIG. 9, a processing unique to the third embodiment will be described.

FIG. 9 shows a flowchart indicating a processing by the adaptor 103.

When updating the voice recognition database 304, which is installed on the adaptor 103, based on date information of a selected image and adding voice information based on an optimal voice recognition result, first, in step S901, an image information control section 301 obtains filenames of all image data stored in the digital camera 102 and stores them as image list information.

Next, in step S902, the image information control section 301 waits for an image selection button 213 to be pressed, which would select the image data to add voice information to and to send. After displaying and confirming the desired image data on the display panel of the digital camera 102, a user presses the image selection button 213 of the adaptor 103.

When the image selection button 213 is pressed, the image information control section 301 obtains via a camera interface 201 the image data displayed on the display panel of the digital camera 102 and stores it. When the image information control section 301 finishes obtaining and storing the image data, it notifies a voice data obtaining section 302 and a transmission file storage section 306 that obtaining the image data has been completed.

Next, in step S903, the user instructs the adaptor 103 whether to update the voice recognition database 304 that would be used to add voice information to the selected image data. In the present embodiment, this instruction is given by pressing a transmission button 211 and the image selection button 213 simultaneously, but a new button for this purpose may be added to the adaptor 103.

If the user instructs to update the voice recognition database 304, the processing proceeds to step S904 and an adaptor information management section 308 obtains date information for the image data that was obtained by the image information control section 301. If the image is an image that was photographed using a normal digital camera, the date and time information of when the photograph was taken is recorded automatically and this information should be read. After obtaining the date information for the image data, the adaptor information management section 308 instructs a communication control section 307 to update the voice recognition database 304.

Next, upon receiving the instruction to update the voice recognition database 304 from the adaptor information management section 308, the communication control section 307 in step S905 controls a portable communication terminal 104 via a communication terminal interface 208 and begins a connection processing with an application server 108.

Next, when the connection with the application server 108 is established, the adaptor information management section 308 in step S906 sends the date information to the application server 108 and waits for a voice recognition database 304 based on the date information to arrive. A plurality of voice recognition databases for various dates, such as databases covering names or characteristics of flora and fauna, place names and events typical of each month or season, are provided in the application server 108; when the date information is received from the adaptor 103, the voice recognition database 304 that matches the date information is sent to the adaptor 103.

Upon confirming that the communication control section 307 received the voice recognition database 304, the adaptor information management section 308 in step S907 registers the voice recognition database 304 that was received and terminates the processing.

If there was no instruction to update the voice recognition database 304 in step S903, the voice data obtaining section 302 and the transmission file storage section 306, both of which received the notice that obtaining the image data has been completed from the image information control section 301, monitor in step S908 for the user to press a voice input button 212 and the transmission button 211, respectively.

To send the selected image data to the application server 108, the user presses the transmission button 211, which controls the portable communication terminal 104, to perform a transmission processing. To add voice information to the selected image data, the user presses the voice input button 212, which controls a voice processing section 204, to input a voice message through a microphone 203.

When the user presses the transmission button 211, the processing proceeds to step S915 and the transmission file storage section 306 begins the transmission processing. When the user presses the voice input button 212, the processing proceeds to step S909 and the voice data obtaining section 302 begins a voice processing. When the user presses the image selection button 213, the processing returns to step S902 to obtain another image data.

<When the Voice Input Button 212 is Pressed>

When the voice data obtaining section 302 detects that the voice input button 212 has been pressed in step S908, the processing proceeds to step S909 and the voice data obtaining section 302 controls the voice processing section 204 to begin inputting and recording the user's voice message through the microphone 203. Further, the voice data obtaining section 302, in addition to inputting and recording the user's voice message, converts the voice message that was input into appropriate digital data and sends it to a voice recognition/keyword extraction section 303. When the recording of the voice message is completed, the voice data obtaining section 302 stores the recorded message as a voice file and notifies the transmission file storage section 306 that the creation of the voice file is completed.

Next, in step S910, the voice recognition/keyword extraction section 303 uses the voice recognition database 304 to recognize, through a word spotting voice recognition technology, the voice data it received from the voice data obtaining section 302, and extracts one or more words as keywords (character string data) from the voice data.

Next, in step S911, a voice information setting section 305 stores as keywords for image searches the keywords (character string) that were extracted by the voice recognition/keyword extraction section 303.

Next, in step S912, the voice information setting section 305 selects one keyword from the keywords that were set as the keywords for image searches and sets and stores the selected keyword as the title of the image data. When doing this, the voice information setting section 305 refers to a list of image filenames, which is stored in the image information control section 301, for image data already sent and sets the title of the image data so as not to duplicate any existing image filenames referred to.

Next, in step S913, the voice information setting section 305 writes in a voice information file 401 the keywords and the image data title that were stored in step S911 and step S912. Further, the voice information setting section 305 writes in the voice information file 401 the filename (the filename stored in the digital camera 102) of the selected image data and the new filename as replaced with the title set (see FIG. 4). After the creation of the voice information file 401 is completed, the voice information setting section 305 notifies the transmission file storage section 306 and the image information control section 301 that the creation of the voice information file 401 has been completed.

Next, upon receiving from the voice information setting section 305 the notice that the creation of the voice information file 401 has been completed, the image information control section 301 refers in step S914 to the title (the character string data) set by the voice information setting section 305 and rewrites the filename of the corresponding image data in the digital camera 102 as the character string data as represented by the title set. Once rewriting the filename is completed, the processing returns to step S908.

As in the first embodiment, it is preferable not to change the filenames themselves inside the digital camera 102 and instead to store the filenames as auxiliary information correlated with respective image data. The reasons for this are to eliminate the inconvenience of not being able to manage images as a result of having filenames in formats other than the DCF, and to be able to recognize the image data with new filenames assigned at the destination, which can be done as long as the filenames are stored as auxiliary information.

More preferably, the new filenames may be stored as auxiliary information along with information used to recognize the destination. By doing this, even if different filenames for a single image data are assigned by various destinations, the image data with the new filenames assigned at various destinations can still be recognized.

<When the Transmission Button 211 is Pressed>

When the transmission file storage section 306 detects that the transmission button 211 has been pressed in step S908, the processing proceeds to step S915 and the transmission file storage section 306 obtains the image data (an image file) from the image information control section 301, the voice file from the voice data obtaining section 302, and the voice information file 401 from the voice information setting section 305.

When there is no notice from the voice data obtaining section 302 that the creation of the voice file has been completed, i.e., when the user did not input any voice messages, the transmission file storage section 306 stores only the image data. After obtaining all files to be sent, the transmission file storage section 306 notifies the communication control section 307 that obtaining files to be sent has been completed.

Next, upon receiving the notice from the transmission file storage section 306 that obtaining the files to be sent has been completed, the communication control section 307 in step S916 controls the portable communication terminal 104 via the communication terminal interface 208 and begins a connection processing with the application server 108. In the connection processing with the application server 108, the communication control section 307 uses the telephone number of the portable communication terminal 104 and an adaptor ID, which are stored in a ROM 205 of the adaptor 103 and are required for connection, for a verification processing with the application server 108.

Next, when the connection with the application server 108 is established, the communication control section 307 in step S917 sends to the application server 108 via the communication terminal interface 208 and the portable communication terminal 104 the files that were obtained by the transmission file storage section 306 and that are to be sent, and terminates the processing.

A more preferable embodiment is one in which the communication control section 307, after connecting with the application server 108 in step S916, inquires whether, in the application server 108, there are any data whose filenames are identical to the filename of the image to be sent, and if there is an identical filename, a different filename is created for the image to be sent by using a different keyword or using the same keyword with a numeral added thereto.

By doing this, any duplication of filenames in the application server 108 can be prevented.

The method for obtaining a specific image data from the digital camera 102, receiving from the application server 108 the voice recognition database 304 that matches the date information of the image data, recording and voice-recognizing a voice message that is input, extracting some words from the message and converting them into text data, and automatically setting the text data as keywords for image searches and a title, all of which takes place in the adaptor 103 of the information processing system, is as described using the flowchart in FIG. 9. However, the order of the steps that take place in the adaptor 103 and that are involved in attaching voice information to an image data based on the voice recognition database 304 received and transmitting the result may be different, as long as the steps include controlling the digital camera 102, inputting voice data, recognizing the voice data, extracting keywords from the voice data, automatically setting an image title and keywords, controlling the portable communication terminal 104, and transmitting a specific file.

[Fourth Embodiment]

The functions of the overall system of the fourth embodiment are fundamentally similar to those of the third embodiment. However, the two differ in that in the fourth embodiment, an adaptor 103 has a positional information processing section to recognize the position of the adaptor 103, which results in the adaptor 103's updating a voice recognition database 304 that is typical of the adaptor 103's positional information and thereby improving the voice recognition rate. This involves updating the voice recognition database 304 using a phonemic model, a grammar analysis dictionary and recognition grammar that take into consideration place names, institutions, local products and dialects typical of an area, for example, in one country, based on the adaptor 103's positional information, in order to improve the recognition rate of voice data taken in.

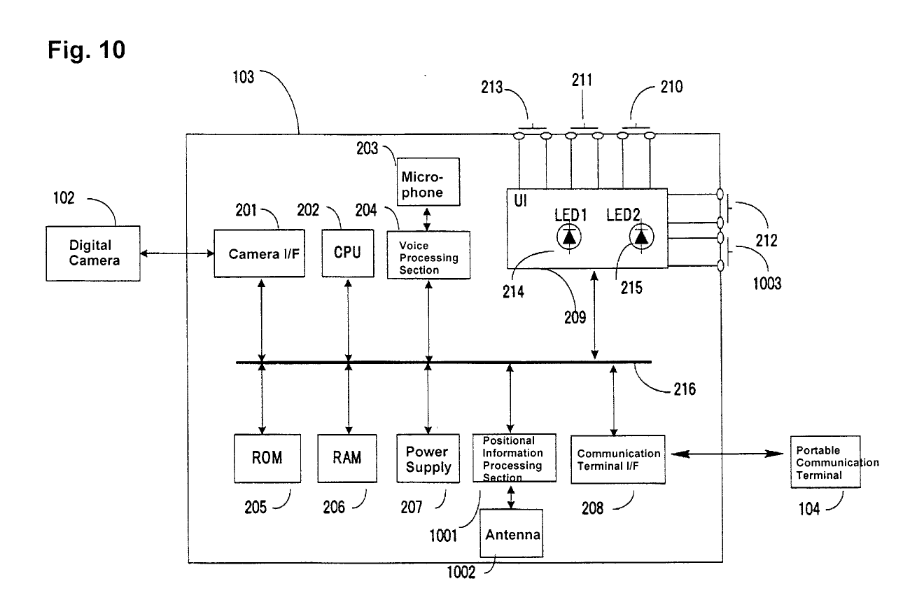

FIG. 10 is a block diagram indicating the electrical configuration of the adaptor 103 according to the fourth embodiment. Although the basic configuration is similar to the block diagram in FIG. 2 as described in the first embodiment, the electrical configuration according to the present embodiment differs from the one in the first embodiment in that the adaptor 103 has a positional information processing section and an antenna to recognize its own position, as well as a user interface for positional information processing.

In the adaptor 103 according to the present embodiment, a positional information processing section 1001 that recognizes the adaptor 103's own position is connected to an internal bus 216. The positional information processing section 1001 is a positional information recognition system that utilizes a GPS (global positioning system), and it can obtain radio wave information that is received from GPS satellites (man-made satellites) via an antenna 1002 and calculate its own position based on the radio wave information received, or it can utilize a portable communication terminal 104 to recognize its position. The positional information processing section 1001 can obtain the positional information of the adaptor 103 in terms of its latitude, longitudinal and altitude via the antenna 1002.

A user interface (U/I) 209 has a positional information transmission button 1003 that receives the voice recognition database 304 based on the positional information of the adaptor 103.

In FIG. 10, all components other than the positional information processing section 1001, the antenna 1002 and the positional information transmission button 1003 are the same as those in the first embodiment.

The electrical configuration of the adaptor 103 has been indicated as illustrated in FIG. 10, but different configurations may be used as long as the configuration allows the adaptor 103 to obtain its positional information, the control of a digital camera 102, voice processing, the control of the portable communication terminal 104, the transmission of specific files, the transmission of its own positional information, and the reception of specific data based on its own positional information.

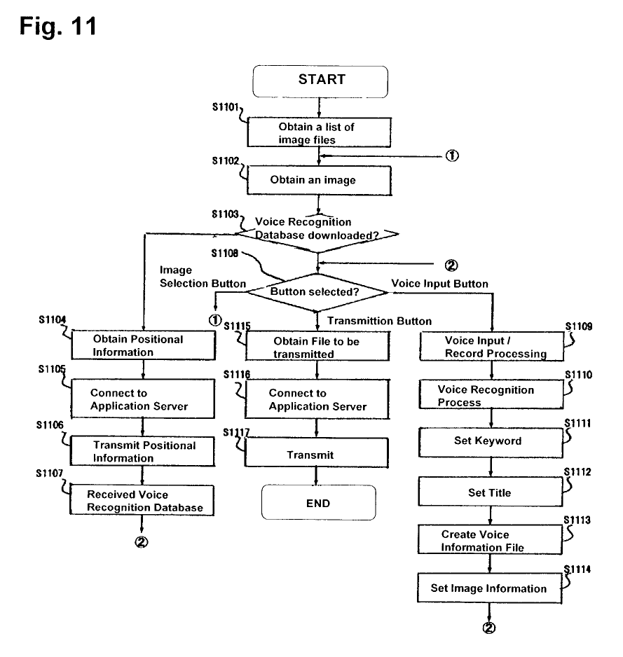

Next, we will use a flowchart in FIG. 11 to describe a processing unique to the fourth embodiment.

FIG. 11 shows a flowchart indicating a processing by the adaptor 103.

When updating the voice recognition database 304, which is installed on the adaptor 103, based on the positional information of the adaptor 103 and adding voice information based on an optimal voice recognition result, first, in step S1101, an image information control section 301 obtains filenames of all image data stored in the digital camera 102 and stores them as image list information.

Next, in step S1102, the image information control section 301 waits for an image selection button 213 to be pressed, which would select the image data to add voice information to and to send. After displaying and confirming the desired image data on the display panel of the digital camera 102, a user presses the image selection button 213 of the adaptor 103.

When the image selection button 213 is pressed, the image information control section 301 obtains and stores via a camera interface 201 the image data displayed on the display panel of the digital camera 102. When the image information control section 301 finishes obtaining and storing the image data, it notifies a voice data obtaining section 302 and a transmission file storage section 306 that obtaining the image data has been completed.

Next, by pressing a positional information transmission button 1003 in step S1103, the user can instruct the adaptor 103 to update the voice recognition database 304 that would be used when adding voice information to the selected image data.

If the user instructs to update the voice recognition database 304, i.e., when the positional button transmission 1003 is pressed, the processing proceeds to step S1104 and an adaptor information management section 308 obtains positional information on its own location, such as latitude, longitude and altitude, from the positional information processing section 1001. Upon receiving a request to obtain positional information from the adaptor information management section 308, the positional information processing section 1001 calculates its own positional information and sends the result to the adaptor information management section 308 via the antenna 1002.

After obtaining its own positional information, the adaptor information management section 308 instructs a communication control section 307 to update the voice recognition database 304.

Next, upon receiving the instruction to update the voice recognition database 304 from the adaptor information management section 308, the communication control section 307 in step S1105 controls the portable communication terminal 104 via a communication terminal interface 208 and begins a connection processing with an application server 108.

Next, when the connection with the application server 108 is established, the adaptor information management section 308 in step S1106 sends its own positional information to the application server 108 and waits for the voice recognition database 304 based on the information to arrive. A plurality of voice recognition databases 304 for various positional information, such as databases covering place names, institutions, local products or dialects typical of a region, are provided in the application server 108; when the positional information is received from the adaptor 103, the voice recognition databases 304 that matches the positional information is sent to the adaptor 103.

Upon confirming that the communication control section 307 received the voice recognition database 304, the adaptor information management section 308 in step S1107 registers the voice recognition database 304 that was received and terminates the processing.

If there was no instruction to update the voice recognition database 304 in step S1103, the voice data obtaining section 302 and the transmission file storage section 306, both of which received the notice that obtaining the image data has been completed from the image information control section 301, monitor in step S1108 for the user to press a voice input button 212 and a transmission button 211, respectively.

To send the selected image data to the application server 108, the user presses the transmission button 211, which controls the portable communication terminal 104, to perform a transmission processing. To add voice information to the selected image data, the user presses the voice input button 212, which controls a voice processing section 204, to input a voice message through a microphone 203.

When the user presses the transmission button 211, the processing proceeds to step S1115 and the transmission file storage section 306 begins the transmission processing. When the user presses the voice input button 212, the processing proceeds to step S1109 and the voice data obtaining section 302 begins a voice processing. When the user presses the image selection button 213, the processing returns to step S1102 to obtain another image data.

<When the Voice Input Button 212 is Pressed>

When the voice data obtaining section 302 detects that the voice input button 212 has been pressed in step S1108, the processing proceeds to step S1109 and the voice data obtaining section 302 controls the voice processing section 204 to begin inputting and recording the user's voice message through the microphone 203. Further, the voice data obtaining section 302, in addition to inputting and recording the user's voice message, converts the voice message that was input into appropriate digital data and sends it to a voice recognition/keyword extraction section 303. When the recording of the voice message is completed, the voice data obtaining section 302 stores the recorded message as a voice file and notifies the transmission file storage section 306 that the creation of the voice file is completed.

Next, in step S1110, the voice recognition/keyword extraction section 303 uses the voice recognition database 304 to recognize, through a word spotting voice recognition technology, the voice data it received from the voice data obtaining section 302, and extracts one or more words as keywords (character string data) from the voice data.

Next, in step S1111, a voice information setting section 305 stores as keywords for image searches the keywords (character string) that were extracted by the voice recognition/keyword extraction section 303.

Next, in step S1112, the voice information setting section 305 selects one keyword from the keywords that were set as the keywords for image searches and sets and stores the selected keyword as the title of the image data. When doing this, the voice information setting section 305 refers to a list of image filenames, which is stored in the image information control section 301, for image data already sent and sets the title of the image data so as not to duplicate any existing image filenames referred to.

Next, in step S1113, the voice information setting section 305 writes in a voice information file 401 the keywords and the image data title that were stored in step S1111 and step S1112. Further, the voice information setting section 305 writes in the voice information file 401 the filename (the filename stored in the digital camera 102) of the selected image data and the new filename as replaced with the title set (see FIG. 4). After the creation of the voice information file 401 is completed, the voice information setting section 305 notifies the transmission file storage section 306 and the image information control section 301 that the creation of the voice information file 401 has been completed.

Next, upon receiving from the voice information setting section 305 the notice that the creation of the voice information file 401 has been completed, the image information control section 301 refers in step S1114 to the title (the character string data) set by the voice information setting section 305 and rewrites the filename of the corresponding image data in the digital camera 102 as the character string data as represented by the title set. Once rewriting the filename is completed, the processing returns to step S1108.

It is more preferable not to change the filenames themselves inside the digital camera 102 and instead to store the filenames as auxiliary information correlated with respective image data. The reasons for this are to eliminate the inconvenience of not being able to manage images as a result of having filenames in formats other than the DCF, and to be able to recognize the new filenames assigned at the destination, which can be done as long as the filenames are stored as auxiliary information.

Even more preferably, the new filenames may be stored as auxiliary information along with information used to recognize the destination. By doing this, even if different filenames for a single image data are assigned by various destinations, the image data with the new filenames assigned at various destinations can still be recognized.

<When the Transmission Button 211 is Pressed>

When the transmission file storage section 306 detects that the transmission button 211 has been pressed in step S1108, the processing proceeds to step S1115 and the transmission file storage section 306 obtains the image data (an image file) from the image information control section 301, the voice file from the voice data obtaining section 302, and the voice information file 401 from the voice information setting section 305.

When there is no notice from the voice data obtaining section 302 that the creation of the voice file has been completed, i.e., when the user did not input any voice messages, the transmission file storage section 306 stores only the image data. After obtaining all files to be sent, the transmission file storage section 306 notifies the communication control section 307 that obtaining files to be sent has been completed.

Next, upon receiving the notice from the transmission file storage section 306 that obtaining the files to be sent has been completed, the communication control section 307 in step S1116 controls the portable communication terminal 104 via the communication terminal interface 208 and begins a connection processing with the application server 108. In the connection processing with the application server 108, the communication control section 307 uses the telephone number of the portable communication terminal 104 and an adaptor ID, which are stored in the ROM 205 of the adaptor 103 and are required for connection, for a verification processing with the application server 108.

Next, when the connection with the application server 108 is established, the communication control section 307 in step S1117 sends to the application server 108 via the communication terminal interface 208 and the portable communication terminal 104 the files that were obtained by the transmission file storage section 306 and that are to be sent, and terminates the processing. A more preferable embodiment is one in which the communication control section 307, after connecting with the application server 108 in step S1116, inquires whether, in the application server 108, there are any data whose filenames are identical to the filename of the image to be sent, and if there is an identical filename, a different filename is created for the image to be sent by using a different keyword or using the same keyword with a numeral being added thereto.

The method for obtaining specific image data from the digital camera 102, obtaining positional information on the location of the adaptor 103, receiving from the application server 108 the voice recognition database 304 that matches the positional information, recording and voice-recognizing a voice message that is input, extracting some words from the message and converting them into text data, and automatically setting the text data as keywords for image searches and a title, all of which takes place in the adaptor 103 of the information processing system, is as described using the flowchart in FIG. 11; however, the order of the steps that take place in the adaptor 103 and that are involved in attaching voice information to image data based on the voice recognition database 304 received and transmitting the result may be different, as long as the steps include controlling the digital camera 102, obtaining positional information of the adaptor 103, inputting voice data, recognizing the voice data, extracting keywords from the voice data, automatically setting an image title and keywords, controlling the portable communication terminal 104, transmitting a specific file, and receiving the voice recognition database 304 based on the positional information.

The voice recognition processing, the keyword extraction processing and the filename change processing in the third and fourth embodiments may be performed in the application server 108 as in the second embodiment.

As described above, when image data photographed with a digital camera is selected and voice data (a voice message) is input in the first and second embodiments, keywords are automatically extracted from the voice message and one of the keywords is selected as a title and becomes set as the filename of the image data, while the extracted keywords becomes set as data to be used in image searches.

In this way, according to the first and second embodiments, the filename and keywords for searches are automatically set by simply inputting a voice message; consequently, the waste in terms of repeatedly inputting keywords for image searches and filenames, which tend to be similar, that was done conventionally can be eliminated, and filenames and search keywords can be set efficiently. Furthermore, since messages are voice-input, there is no keyboard inputting; this further facilitates efficiently setting filenames and search keywords.

In addition, since there is no need to consider which phrase should be used as search keywords and which phrase should be used as a filename, efficient setting of filenames and search keywords is even more facilitated.

Furthermore, according to the first and second embodiments, a filename (keywords and title) that is not used for any other image data is automatically extracted from a voice message; consequently, there is no need as in the past to be careful not to input a filename that has been used before when inputting a filename, which also helps to efficiently set filenames and search keywords.

The present invention is not limited to the first and second embodiments, so that, for example, by configuring the adaptor 103 according to the first embodiment and the application server 108 according to the second embodiment, and by providing a transmission mode switching switch in the adaptor 103, a title and keywords can be sent simultaneously with an image data as in the first embodiment, or an image data can be sent first and a title and keywords can be sent later as in the second embodiment, whichever serves the user's needs.

Moreover, the digital camera itself can have a communication function, as well as the functions of the adaptor 103 according to the first embodiment, and/or it can have a positional information obtaining function such as the GPS used in the fourth embodiment.

In the third and fourth embodiments, the voice recognition database used to analyze voice messages input through a microphone can be updated based on date information of image data recorded by a digital camera or on positional information of the location of the adaptor 103; this improves the voice recognition rate for the applicable image data, which in turn makes it possible to efficiently set optimal filenames and search keywords.

By providing in the application server 108 a plurality of voice recognition databases to be updated based on information from the adaptor 103, filenames and search keywords can always be set using the optimal and latest databases without the user having to be aware of a customizing processing, in which the user personally creates a voice recognition database.

Additionally, the digital camera itself can have a communication function, as well as the functions of the adaptor 103 according to the third and fourth embodiments.

The present invention is applicable when program codes of software that realize the functions of the embodiments described above are provided in a computer of a system or a device connected to various devices designed to operate to realize the functions of the embodiments described above, and the computer (or a CPU or an MPU) of the system or the device operates according to the program codes stored to operate the various devices and thereby implements the functions of the embodiments.

In this case, the program codes of software themselves realize the functions of the embodiments described above, so that the program codes themselves and a device to provide the program codes to the computer, such as a storage medium that stores the program codes, constitute the present invention.

The storage medium that stores the program codes may be a floppy disk, a hard disk, an optical disk, an optical magnetic disk, a CD-ROM, a magnetic tape, a nonvolatile memory card or a ROM.

Furthermore, needless to say, the program codes are included as the embodiments of present invention not only when the computer executes the program codes supplied to realize the functions of the embodiments, but also when the program codes realize the functions of the embodiments jointly with an operating system or other application software that operates on the computer.

Moreover, needless to say, the present invention is applicable when the program codes supplied are stored in an expansion board of a computer or on a memory of an expansion unit connected to a computer, and a CPU provided on the expansion board or the expansion unit performs a part or all of the actual processing based on the instructions contained in the program codes and thereby realizes the functions of the embodiments.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An image management apparatus that transmits image data to an image processing apparatus, the image management apparatus comprising:
an image input unit that inputs image data to be transmitted;
a sound input unit that inputs voice information relating to the image data input via the image input unit;
a translator that voice-recognizes the voice information input via the sound input unit and converts the voice information into keyword information containing at least one keyword; and
a transmission unit that adds the keyword information to the image data and transmits the image data with the keyword information to the image processing apparatus.

2. An image management apparatus according to claim 1, wherein the keyword information contains a plurality of keywords, and the transmission unit selects at least one of the plurality of keywords and adds keyword information containing the at least one of the plurality of keywords selected to the image data upon transmitting the image data to the image processing apparatus.

3. An image management apparatus according to claim 1, wherein the transmission unit transmits the at least one keyword as a title for the image data.

4. An image management apparatus according to claim 1, wherein the image input unit inputs image data retrieved from a memory that stores image data under a predetermined file name, and
the transmission unit includes a file name conversion unit that converts the predetermined file name using the at least one keyword.

5. An image management apparatus according to claim 4, further comprising a unit that correlates a new file name that has been converted by the file name conversion unit to the image data having the file name before conversion, and stores the image data correlated to the new file name.

6. An image management apparatus according to claim 1, further comprising a photographing unit, wherein file names for images photographed by the photographing unit are generated according to a DCF format.

7. An image management apparatus according to claim 1, further comprising an obtaining unit that obtains time information correlated to the image data to be transmitted, wherein the translator extracts keywords based on the voice information and the time information.

8. An image management apparatus according to claim 1, further comprising an obtaining unit that obtains geographical positional information correlated to the imaged data to be transmitted, wherein the translator extracts keywords based on the voice information and the positional information.

9. An image management apparatus according to claim 1, wherein the translator inquires file names of data that are managed by the image processing apparatus, and uses the at least one keyword to generate a file name different from the file names of data that are managed by the image processing apparatus.

10. An image management apparatus that receives image data from an image processing apparatus, the image management apparatus comprising:
a receiving unit that receives image data from the image processing apparatus;
a sound input unit that inputs voice information relating to the image data input via the receiving unit;
a translator that voice-recognizes the voice information input via the sound input unit and converts the voice information into keyword information containing at least one keyword; and
a storage unit that adds the keyword information to the image data and stores the image data with the keyword information added thereto in a memory.

11. An image management apparatus according to claim 10, wherein the keyword information contains a plurality of keywords, and the storage unit selects at least one of the plurality of keywords and adds keyword information containing the at least one of the plurality of keywords to the image data upon storing the image data in the memory.

12. An image management apparatus according to claim 10, wherein the storage unit stores the at least one keyword as a title for the image data.

13. An image management apparatus according to claim 10, wherein the image data received by the receiving unit has a predetermined file name, and
the storage unit includes a file name conversion unit that converts the predetermined file name using the at least one keyword.

14. An image management apparatus according to claim 13, further comprising a transmission unit that correlates a new file name that has been converted by the file name conversion unit to the image data having the file name before conversion, and transmits the image data correlated to the new file name to the image processing apparatus.

15. An image management apparatus according to claim 10, wherein the image processing apparatus includes a digital photographing unit, wherein file names for images photographed by the digital photographing unit are generated according to a DCF format.

16. An image management method that transmits image data to an image processing apparatus, the image management method comprising:
an image input step of inputting image data to be transmitted;
a sound input step of inputting voice information relating to the image data input in the image input step;
a translation step of voice-recognizing the voice information input in the sound input step and converting the voice information into keyword information containing at least one keyword; and
a transmission step of adding the keyword information to the image data and transmitting the image data with the keyword information added thereto.

17. An image management method according to claim 16, wherein the keyword information contains a plurality of keywords, and the transmission step selects at least one of the plurality of keywords and adds keyword information containing the at least one of the plurality of keywords to the image data upon transmitting the image data.

18. An image management method that receives image data from an image processing unit, the image management method comprising:
a receiving step of receiving image data from the image processing unit;
a sound inputting step of inputting voice information relating to the image data input in the receiving step;
a translating step of voice-recognizing the voice information input in the sound input step and converting the voice information into keyword information containing at least one keyword; and
a storing step of adding the keyword information to the image data and storing the image data with the keyword information added thereto in a memory.

19. An image management method according to claim 18, wherein the keyword information contains a plurality of keywords, and the storing step selects at least one of the plurality of keywords and adds keyword information containing the at least one of the plurality of keywords to the image data upon storing the image data in the memory.

20. An image management program for performing a process that transmits image data to an image processing apparatus, wherein the image management program performs the process comprising:
an image input step of inputting image data to be transmitted;
a sound input step of inputting voice information relating to the image data input in the image input step;
a translation step of voice-recognizing the voice information input in the sound input step and converting the voice information into keyword information containing at least one keyword; and
a transmission step of adding the keyword information to the image data and transmitting the image data with the keyword information added thereto.

21. An image management program according to claim 20, wherein the keyword information contains a plurality of keywords, and the transmission step selects at least one of the plurality of keywords and adds keyword information containing the at least one of the plurality of keywords to the image data upon transmitting the image data.

22. A storage medium that stores the image management program recited in claim 20.

23. An image management program for performing a process that receives image data from an image processing unit, wherein the image management program performs the process comprising:
a receiving step of receiving image data from the image processing unit;
a sound inputting step of inputting voice information relating to the image data input in the receiving step;
a translating step of voice-recognizing the voice information input in the sound input step and converting the voice information into keyword information containing at least one keyword; and
a storing step of adding the keyword information to the image data and storing the image data with the keyword information added thereto in a memory.

24. An image management method according to claim 23, wherein the keyword information contains a plurality of keywords, and the storing step selects at least one of the plurality of keywords and adds keyword information containing the at least one of the plurality of keywords to the image data upon storing the image data in the memory.

25. A storage medium that stores the image management program recited in claim 23.
